(19) United States
(12) Patent Application Publication
(10) Pub. No.: US 2009/0210277 A1
(43) Pub. Date: Aug. 20, 2009

(54) System and method for managing a geographically-expansive construction project

(76) Inventors: H. Wesley Hardin, Gladstone, MO (US); J. Brett Williams, Killingworth, CT (US)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 12/070,242

(22) Filed: Feb. 15, 2008

Related U.S. Application Data
(60) Provisional application No. 61/065,787, filed on Feb. 14, 2008.

(51) Int. Cl. G06Q 90/00

(52) U.S. Cl. 705/8

(57) ABSTRACT

In an exemplary embodiment, a system for managing a geographically-expansive construction project includes a database of construction project data, the data including geographic location information, terrain data having geographic location information, and a geographic information system (GIS) operable to display the construction project data and terrain data in proper geographic correlation so that a project manager or other user can visually monitor view the status of the construction project. The project manager and other users can update construction project data so that the status display maintains a current view of the construction project. Input from owners of properties affected by the construction project is entered by customer relations representatives, that input is viewable by the project manager as well as field crews working on the construction project. Associated exemplary methods are also presented.

### CROSS-REFERENCE TO RELATED APPLICATIONS

The present application is related to and claims the benefit of priority of U.S. Provisional Application Ser. No. ______, filed Feb. 14, 2008, entitled “System and Method for Geospatial Project Management”, of which the present application is a non-provisional application thereof. The disclosure of the foregoing application is hereby incorporated by reference in its entirety herein, including any appendices or attachments thereof, for all purposes.

### STATEMENT REGARDING FEDERALLY SPONSORED RESEARCH OR DEVELOPMENT

Not applicable.

### BACKGROUND OF THE INVENTION

1. Field of the Invention

The present invention relates to a system and method of managing a geographically-expansive construction project. More specifically, the present invention relates to a system and method of managing a transmission line construction project that spans a large geographical area, using geospatial tracking and management tools.

2. Description of Related Art

In the construction industry, effective management of project progress is essential in order to remain competitive. Tracking the progress of individual components and activities of a project allows more effective scheduling of resources, which in turn eliminates wasted time and effort. However, management and tracking of projects covering large geographical areas, such as utility installations of power transmission lines and the like presents difficulties not encountered in single-site construction projects. Unlike single-site projects, a transmission line project may literally extend for tens, or hundreds, of miles, with various portions of the project being in different stages of completion at any given time. Also, unlike single-site projects, it is not possible for a single “site manager” to be in place at every location of a large transmission line project to oversee and track the progress of the project. While software exists to help manage and track large-scale projects, that software is typically directed to specific aspects of the project (e.g., construction status, property-owner input, etc.), with little or no correlation or aggregation of information between the various aspects. In addition, when information is collected, the updated information is not distributed to project manager and field crews in a timely manner. Thus, there is typically no up-to-date, overall project tracking and status information available to project managers, field crews, site managers, or to the general public. Furthermore, there is no single-source report of data aggregated from the various components of the project available to present to any user in an easy to view and understand, user-friendly format.

### BRIEF SUMMARY OF THE INVENTION

The present invention is directed to a system and method for managing a geographically-expansive construction project.

In an exemplary embodiment, a system for managing a geographically-expansive construction project includes a database server that stores various construction project data, including structure design data, property data, and terrain data. The construction project data items include geographic location information so that the geospatial location of the item (e.g., a structure or property parcel) can be ascertained. The system further includes a server running a geographic information system (GIS) application operable to display features (representing the construction project data) and terrain data in geographic correlation so that the construction project data appears overlaid on the terrain data.

The aggregated information (construction project data and terrain data) is displayed on a “geospatial project dashboard” user screen that allows a project manager or other user to visually monitor the status of the construction project in conjunction with a “map” view of the project laid out on an actual land image (e.g., terrain data) of the area encompassed by the project. Different construction project data items are displayed as different types of icons (e.g., a transmission line pole appears as a to-scale pole, transmission line wires appear as wires at the appropriate elevation, customer-relations issues or other property issues appear as flags, etc.). The GIS application allows a user to zoom-in, zoom-out, and choose camera angles (i.e., perspective viewing angles) in which to view the entire project or various selected portions. The system further includes a project management and scheduling application that allows users to input and manipulate construction project data, and a translations application that converts geographic location information in various formats to a common format used by the GIS application.

In exemplary methods, the system is used to manage the construction of a geographically-expansive transmission line construction project, including the overhead portion, the underground portion, and property issues related to the project.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

This patent application contains a plurality of drawings, some of which are executed in color. Copies of the patent application, with the color drawings, will be provided by the Patent Office upon request and payment of the necessary fee.

It should also be noted that FIGS. 5-8 and 11-16 are line drawings of “screen captures” of user display screens associated with the geographic information system (GIS) application as described herein. Because the background image (e.g., terrain data) associated with those screen captures cannot be accurately depicted with line drawings, the background image portion of those figures has been omitted, but noted in the figures as “—IMAGE—”, indicating that a background image appears in the actual screen display. For clarity, color versions of many of these figures have been provided which include the underlying background image as well as color-coded display information not able to be depicted in the line drawings.

FIG. 1 is a block diagram of an exemplary system for managing a geographically-expansive construction project in accordance with the present invention.

FIG. 2 is a block diagram of the geospatial computer system of FIG. 1.

FIG. 3 is a color photograph “screen capture” of a “geospatial project dashboard” user screen of the system of FIG. 1, showing color-coded features corresponding to construction project data overlaid on a background image.

FIG. 4 is a “screen capture” depiction of a “Daily Schedule Record” screen of the program management and scheduling application of the geospatial computer system of FIG. 2.

FIG. 5 is a “screen capture” depiction of a “geospatial project dashboard” user screen of the system of FIG. 1 displaying a zoomed-in view of an underground portion of the construction project.

FIG. 6 is a “screen capture” depiction of a “geospatial project dashboard” user screen of the system of FIG. 1 displaying a zoomed-out view of an underground portion of the construction project.

FIG. 7 is a “screen capture” depiction of a “geospatial project dashboard” user screen of the system of FIG. 1 displaying a zoomed-in view of an overhead portion of the construction project.

FIG. 8 is a “screen capture” depiction of a “geospatial project dashboard” user screen of the system of FIG. 1 displaying a pop-up information window.

FIG. 9 is a “screen capture” depiction of a “Public Contact” data screen of the project management and scheduling application of the system of FIG. 1.

FIG. 10 is a “screen capture” depiction of a “Public Contact Record” data input screen of the project management and scheduling application of the system of FIG. 1.

FIG. 11 is a “screen capture” depiction of a “geospatial project dashboard” user screen of the system of FIG. 1 displaying a first embedded window linked to the project management and scheduling application of the system of FIG. 1

FIG. 12 is a “screen capture” depiction of a “geospatial project dashboard” user screen of the system of FIG. 1 displaying a second embedded window linked to the project management and scheduling application of the system of FIG. 1

FIG. 13 is a “screen capture” depiction of a “geospatial project dashboard” user screen of the system of FIG. 1 displaying a third embedded window linked to the project management and scheduling application of the system of FIG. 1

FIG. 14 is a “screen capture” depiction of a “geospatial project dashboard” user screen of the system of FIG. 1 displaying a fourth embedded window linked to the project management and scheduling application of the system of FIG. 1

FIG. 15 is a “screen capture” depiction of a “geospatial project dashboard” user screen of the system of FIG. 1 displaying a fifth embedded window linked to the project management and scheduling application of the system of FIG. 1

FIG. 16 is a “screen capture” depiction of a “geospatial project dashboard” user screen of the system of FIG. 1 displaying a zoomed-in view of an overhead portion of the construction project and features corresponding to customer issues.

FIG. 17 is a color photograph “screen capture” of the “geospatial project dashboard” user screen of FIG. 5, showing the background image and color-coded features.

FIG. 18 is a color photograph “screen capture” of the “geospatial project dashboard” user screen of FIG. 6, showing the background image and color-coded features.

FIG. 19 is a color photograph “screen capture” of the “geospatial project dashboard” user screen of FIG. 7, showing the background image and color-coded features.

FIG. 20 is a color photograph “screen capture” of the “geospatial project dashboard” user screen of FIG. 11, showing the background image and color-coded features.

FIG. 21 is a color photograph “screen capture” of the “geospatial project dashboard” user screen of FIG. 12, showing the background image and color-coded features.

FIG. 22 is a color photograph “screen capture” of the “geospatial project dashboard” user screen of FIG. 13, showing the background image and color-coded features.

FIG. 23 is a color photograph “screen capture” of the “geospatial project dashboard” user screen of FIG. 14, showing the background image and color-coded features.

FIG. 24 is a color photograph “screen capture” of the “geospatial project dashboard” user screen of FIG. 16, showing the background image and color-coded features.

### DETAILED DESCRIPTION OF AN EXEMPLARY EMBODIMENT OF THE INVENTION

The present invention is directed to a system and method for managing the planning, design, procurement and construction activity of a geographically expansive construction project using a “geospatial project dashboard” to visually present data aggregated from all aspects of the construction project. Construction project data is displayed on the geospatial project dashboard using a geographic information system (GIS) application that allows a user to easily and intuitively view, interpret, and expand the presented information. While the invention will be described in detail below with reference to an exemplary embodiment (and exemplary methods of using that embodiment), it should be understood that the invention is not limited to the specific system configurations or methodologies of this embodiment.

For example, although the exemplary embodiment is described primarily in the context of a transmission line construction project, the invention could be used in connection with other types of geographically-expansive construction projects, such as geographically expansive utility, pipeline, telephone or computer network construction projects. In addition, although the exemplary embodiment is described as embodying several different inventive features, one skilled in the art will appreciate that any one of these features could be implemented without the others in accordance with the invention.

### Configuration of the Geographically-Expansive Project Management System

The configuration of the geographically-expansive project management system will now be described in conjunction with an exemplary embodiment of the invention. The individual components of the system will first be described, with a brief description of the functionality of those elements. The interrelationship of those elements and operation of the entire system will be described below after the introduction of each component.

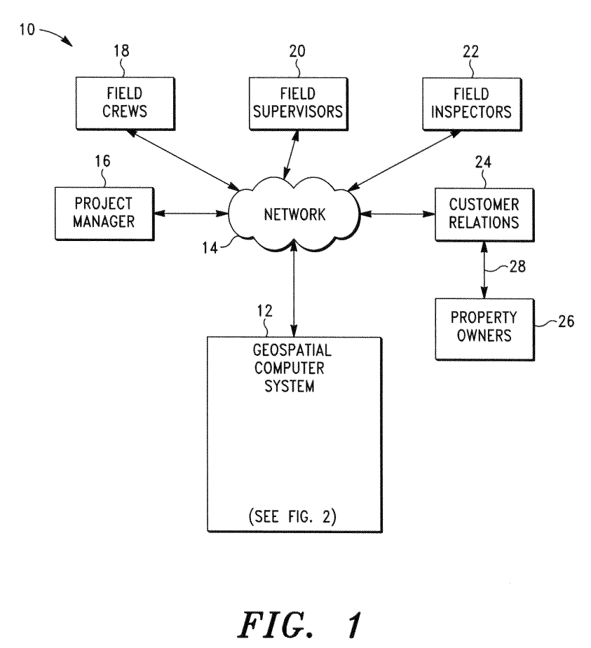

Referring first to FIG. 1, an exemplary system for managing the planning, design, procurement and construction activity of a geographically expansive construction project is depicted generally as reference numeral 10. System 10 includes a geospatial computer system 12 in communication with various users over a network 14. The geospatial computer system is operated by a project manager that is responsible for overseeing all aspects of the transmission line project.

As will be described in more detail herein, the system provides a “geospatial project dashboard” user screen that presents users with an intuitive, integrated, visual interface for accessing and viewing the status of all aspects of the transmission line construction project. The system correlates and aggregates detailed information regarding various aspects and features of the construction project (e.g., project requirements, structures, project status, etc.) with detailed information regarding the geographic location of the construction project (e.g., high-resolution background images, access road information, easement information, etc.). That correlated and aggregated information is displayed on the geospatial project dashboard so that a user can easily view the project and its status in relation to the physical, geographic location of the project. The user's view of the project can be zoomed-out to provide a complete overview of the entire project, or zoomed-in to provide a detailed view of a particular geographic location. A user can obtain even more detailed information regarding a displayed feature by hovering-over, or clicking on, features corresponding to that feature on the display.

The detailed construction project data is stored in various databases accessible by the system. Throughout the project planning, construction, and maintenance phases, the information in the databases is updated by users of the system to reflect the current state of the project. Thus, users of the system have access to up-to-date information, and users of the geospatial project dashboard user screen have current views of the project and its status in an integrated graphical format.

Users of the geospatial computer system 12 generally include a project manager 16 (i.e., the operator of the system and overseer of the entire project), field crews 18 (i.e., workers or contractors performing the field work on the construction project), field supervisors 20 (i.e., supervisors of the field crews); field inspectors 22 (i.e., inspectors of the construction work), customer relations representatives 24 (i.e. representatives of the project manager who deal directly with the customers/property owners via telephone, email, or face-to-face), and property owners 26 (i.e., owners of property affected by the construction project). Each of these users may include a plurality of individual users. For example, the project manager 16 may include several individuals, each responsible for a specific portion of the construction project. Field supervisors may include more than one supervisor overseeing particular aspects of the construction. And property owners may include owners of property directly affected by the construction project (e.g., the construction project encroaches onto their land), or those indirectly affected (e.g., the construction project obstructs their view or access to their property). These users are exemplary of the users involved in a typical transmission line construction project. It should be understood that a particular transmission line construction project may not involve all of these users, or may involve users other than those depicted in FIG. 1. As will be described in more detail below, each of the users may enter and/or view information and data relating to the construction project in accordance with appropriate access and/or security restrictions.

As seen in FIG. 1, users of system 10 access the geospatial computer system 12 via network 14. Network 14 may be a direct connection to the geospatial computer system 12, a local area network (LAN), a wide are network (WAN), the Internet, any other network known in the art, or various combinations of such networks. Different users of the system may use different networks to connect to geospatial computer system 12, or may use combinations of more than one network to connect. For example, a project manager 16 may be co-located in the same building as the geospatial computer system 12, and thus may connect directly to a server within the computer system (as described in more detail herein below), or may connect via a local area network. By contrast, a field supervisor may access the system via a laptop computer using a dial-up, cellular, or wireless connection to the Internet, which in turn connects to geospatial computer system 12. Or, a remote user may use a Virtual Private Network (VPN) connection through the Internet or other network for increased security. Of course, these network connections are exemplary, and these and other methods of providing access to the users of the system will be apparent to those skilled in the art, and are within the scope of the present invention.

With the users of the system 10 able to connect to geospatial computer system 12 as just described, those users are able to view various aspects of the status of the construction project on a “geospatial project dashboard” user screen as will be described in more detail below. Depending on the access rights granted to the particular user, that user may also be able to enter new construction project information or data (which is then stored in the appropriate database, as described below), or may be able to edit or delete existing information from the database. For example, a field crew 18, upon completion of installation of a transmission line pole, may enter the status of that installation using a remote terminal or laptop computer connected to the system. Or, a field supervisor 20, upon noting that vegetation needs to be cleared from a parcel of land, may likewise enter that information into the system using a remote-access device, or via his office computer upon returning to his office.

As also shown in FIG. 1, the customer relations users 24 are in direct communication with property owners 26 such that property owners can provide input to the system 12. In the embodiment shown, property owners 26 do not have direct access to the system. However, it will apparent that in an alternative embodiment of the present invention, a property owner may be permitted to directly access the system in order to view various aspects of the construction project, although they would not be able to enter information into the system or change existing information.

As shown in the exemplary embodiment of FIG. 1, a property owner having a concern or issue that needs to be noted in the system (e.g., a concern that a particular tree on the property not be cut down) contacts a customer relations 24 representative, who enters the information into the system. Of course, there may be some overlap between the user designations shown in FIG. 1. For example, a field supervisor may be approached directly by a property owner having a concern, and the field supervisor can enter that information into the system, rather than requiring the property owner to contact a customer relations representative. Similarly, any of the field supervisors, field inspectors, and field crews may enter information related to the status of the construction project. The user designations are not intended to be limiting as to the type of information that may be entered by that user. Of course, as is known in the art, security and access rights can be granted by the project manager as desired to limit access by any particular user or group of users.

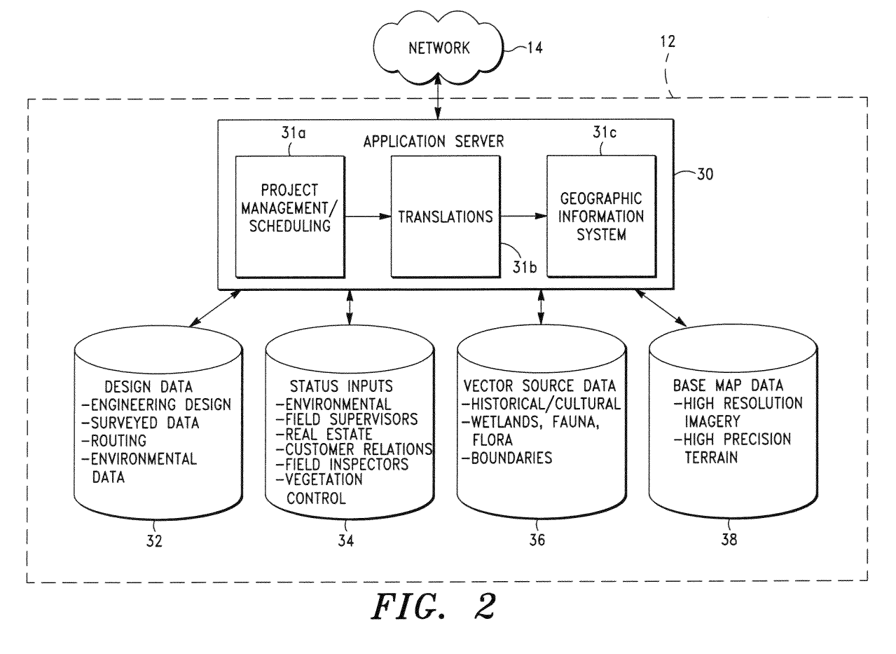

Turning now to FIG. 2, an exemplary embodiment of the geospatial computer system 12 is depicted. The computer system includes an application server 30 in communication with four databases designated “Design Data” 32, “Status Inputs” 34, “Vector Source Data”, and “Base Map Data” 38. Application server 30 is also connected to network 14 (as previously described), allowing the application server to present user screens or web pages to a user in accordance with the screens/pages generated by the software applications running on the application server. Those user screens include functionality for the users to view project status information (i.e., a geospatial project dashboard user screen), or to enter project information and status into various data input fields on the user screens of a project management and scheduling application (as will be described in greater detail below).

While a single application server is depicted in FIG. 2, it should be understood that more application servers may be implemented to distribute user loads across different servers or to provide redundant capability. In addition, that a separate network or web server may be implemented to serve the user screens and web pages to the users over the network 14. Furthermore, separate application servers may be employed to host and run the various software applications. As such, there may be a single application server or multiple application servers in the “server system.” These and other variations in implementation will be apparent to those skilled in the art, and are within the scope of the present invention.

Application server 30 hosts and runs the software applications used by the system, including: (1) a project management and scheduling software application 31a that provides project tracking and management functionality, (2) a translations software application 31b that provides geographic location/coordinate conversion functionality, and (3) a Geographic Interface System (GIS) software application 31c that provides geospatial display functionality.

The project management and scheduling software application 31a is used to collect, manage, track, store, and schedule project information and data. In this exemplary embodiment, the project management and scheduling software application 31a comprises the Primavera® project portfolio management software and Primavera's P6™ scheduling module. The project data is stored in an Oracle® database, with that data being available to the project management and scheduling software application 31a as well as to other applications capable of retrieving information from the database. As is known in the art, the project management and scheduling application provides functionality to enter, track, and schedule any project related information. Of course, other project tracking and management software applications or software may be used. One skilled in the art will appreciate that users are able to utilize the capabilities of the project management and scheduling software via user screens presented to users by the application server 30.

The translations software application 31b translates the geographic location/coordinate information associated with the various construction project data items to a common format (e.g., coordinate system) so that the geographic locations of those various data items can be passed to the geographic information system (GIS) application (as described below) for display on the geospatial project dashboard user screen. Every construction project data item stored by the project management and scheduling software application 31a includes, or is associated with, a geographic location. For example, a transmission line pole scheduled for installation will include, as part of its stored information, the geographic location at which that pole is to be installed.

The format of the geographic location information for each data item will vary, depending on the source of the data. For example, a location of a transmission line pole will typically come from a Computer Aided Design (CAD) data file in which the transmission line construction project was planned and designed. That CAD file includes at least one reference to a physical, geographic location from which the locations of every structure, component, or feature within that CAD file can be determined, typically determined by calculating the distance and elevation of that structure, component, or feature from the reference point. Similarly, a data item relating to a property owner's concern about the construction project relating to their property will typically include a reference to a property address, or a property parcel number, which in turn can be related to a specific geographic location through a property information database (as discussed below). Various other geographic location/coordinate information systems having various location and/or coordinate systems are known in the art, and are in common use. For example, many state surveying databases use a state-plane coordinate system that relate features or data items in the database to a reference location within the state (e.g., a marker at the state capital building). And, many older surveying databases use a coordinate system relating the locations of features within that database to a reference geographical location, such as a tree, post, or other arbitrary marker. Other databases use world latitude and longitude coordinates to locate the features or data items within that database. In the exemplary system of FIG. 2, every data item stored by the project management and scheduling software application 31a that relates to a physical location either explicitly includes, or has a reference to, a geographic location.

Translations software application 31b receives data from the project management and scheduling application 31a, or directly from any of the databases 32, 34, 36, 38, and recognizes the geographic location information of every data item (regardless of the format). That geographic location information is translated to a common format, such as WGS84, a world latitude/longitude coordinate system. With the locations of the data items converted to a common coordinate format, those data items are stored in a data file. Those stored data files are later accessed by the Geographic Information System (GIS) application 31c (discussed in more detail below), which in turn displays those data items as features on the geospatial project dashboard user screen. The translated data is preferably stored in a format compatible with graphic display applications, such as Keyhole Markup Language (KML) format, or the compressed version of that format, KMZ. In this exemplary embodiment, the translations software application 31b comprises Safe Software's FME spatial data conversion program. Of course, other translation/conversion software applications may also be used to perform the required translations as just described, and the data may be stored in formats other than KML.

The Geographic Information System (GIS) software application 31c is operable to receive data having embedded geographic location information, and to display features representative of that data in conjunction with an image corresponding to the geographical area encompassed by that data. For example, features representative of data items related to a transmission line construction project, such as a transmission line pole, are displayed in conjunction with a high-resolution image (e.g., an image created from an aerial photograph) of the corresponding geographical area (which likewise has associated geographical coordinates). Thus, a construction project feature (e.g., a transmission line pole) is displayed as an image representing that feature, along with an icon and/or text, overlaying the high-resolution image of the terrain where the transmission line pole is to be located. In this exemplary embodiment, the Geographic Information System application is Google® Earth Professional, which is operable to receive data files generated by the translations application 31b, and display items or features in those data files in conjunction with a background image (e.g., terrain data) such that those items and/or features appear in their proper geographical location overlaying the background image (e.g., terrain data). Other versions of a GIS application, such as Google® Earth Enterprise, may be used, or other GIS programs having the ability to display terrain data in conjunction with overlaid data may be used.

Different data items from the various databases are displayed as different features by the GIS application, depending on the specifications and styles defined for that feature. Typically, a data item will be represented by a feature comprising an image representing the data item, and/or an icon, and/or text. For example, a relations issue data item will be represented by a flag icon, with an accompanying text identification tag. And, a transmission line pole will display as an image resembling a column (having a length and a width representative of a scaled representation of a pole), with an accompanying text identification tag. The image associated with each feature are three-dimensional images such that the representation of those images on the geospatial project dashboard user screen will appear as a three dimensional image when a perspective view is presented to the user.

In addition to, or in place of, the image portion, a displayed feature may also include an icon portion, and/or a text portion. For example, in the case of a feature representing a physical structure, such as a transmission line pole, in addition to the displayed representative image, the feature may include an icon (such as a ball icon positioned at the end of the pole image). As is known in the art, that icon portion provides a link to the GIS application such that clicking on, or hovering over, the icon can be detected by the GIS application which in-turn can respond to the detected click/hover. In the case of non-structural features, there may be only an icon displayed, with no representative image. For example, a customer relations issue does not have a corresponding “representative image”, but is typically displayed only as a flag icon. The text portion of the feature provides a text or numbered identification tag associated with that feature.

Each displayed construction project data item will thus be represented by a corresponding features, for example, a real estate parcel may be represented by an image of a three-dimensional polygon, and an underground vault may be represented by a three-dimensional image representing the appearance of the accessible, visible portion (i.e., above-ground portion) of the vault.

In addition to the image, icon and text, the feature further includes a color component, such that the color of the feature also represents a status of the data item represented by the feature. For example, a customer relations issue (represented by a flag icon) will be colored red to indicate a pre-construction status, blue to represent a legal issue, green to indicate a vegetation issue, and yellow to indicate a post-construction issue. In addition, the image, icon and/or text used for a particular data item may change to reflect a particular status of the item. For example, a customer relations issue having information that should be viewed by a user will display as a yellow “information” triangle icon (a yellow triangle with an exclamation point), rather than as a flag icon.

The attributes of each feature (including the image, icon, text, and color) for the construction project data items are defined in a “style” file that is accessible by the applications running on the application server 30. The styles are typically stored in a Microsoft® Access® database format. When the GIS application 31c displays a feature corresponding to a construction project data item, the attributes for that features are retrieved from the style file so that the GIS application 31c can display the representative image, and/or icon, and/or text, and/or color-coding for that feature. The default styles for any particular feature are typically defined by the project manager, but may be overridden by users of the system, such as by a project manager wanting a different icon for a particular feature.

The GIS application 31c is thus operable to integrate a background image (e.g., terrain data), with construction project data presented as features overlaid on that background image. A user of the system can thus view the entire transmission line construction project in relation to its actual geospatial location on the background image (e.g., terrain data). Using zoom and camera angle features of the GIS application, a user can view specific portions of the project in various overhead and perspective views. With the construction project data items and features of the construction project having associated geographical coordinates as described above, those features will appear in the proper location, overlaying the high resolution background image (e.g., terrain data).

Looking still to FIG. 2, application server 30 is coupled to four databases 32, 34, 36, 38, each of which stores various data items associated with the construction project and/or data used to display various aspects of the construction project. Note that the term “database server” as used herein is broadly inclusive of any storage device for storing data of any type for access by the application server 30, and is not limited to specific data types or the format in which they are stored. For example, while computer aided design (CAD) data files and terrain data are not typically stored in a conventional database format, the data associated with those CAD files and terrain data are stored on a storage device such as a disc drive, an optical drive, etc. For purposes of the present invention and the exemplary embodiments described herein, “database server” includes any data, in any format, stored on any device accessible by the application server 30.

In a manner similar to that described previously with respect to the application server, the data servers in this exemplary embodiment may be individual storage devices (e.g., hard drives, optical drives, etc.), may be redundant storage devices (e.g., RAID drives, etc.), may be storages devices hosted on servers (e.g., database servers), and may be co-located or dispersed to provide additional capacity and/or redundancy. And, a database server may be a single database server or multiple database servers co-located, or dispersed among different locations. These variations will be apparent to those skilled in the art and are contemplated by the present invention.

In the exemplary embodiment depicted in FIG. 2, construction project data is distributed among the four database servers such that the data is divided generally into four groups, “Design Data”, “Base Map Data”, “Vector Source Data”, and “Status Inputs”, with each group of data being generally stored in a separate database. While these four general groups of data and associated databases will now be described in more detail, it should be understood that overlap between the four groups may exist, or that data generally included in one group may in fact reside within a different database. Or, all of the construction project data may be aggregated into a single database, or dispersed among other databases. These and other variations in the storage of data are within the scope of the present invention.

As seen in FIG. 2, the database servers are in communication with application server 30 such that the software applications running on the application server as previously described can access the various database servers as required. While each software application typically accesses data from specific databases, it should be apparent that all of the database servers are in communication with the application server 30 such that other applications running on the application server may also access the database servers, or such that the described applications may access data from any of the database servers.

As described briefly above, the construction project data stored in the database servers includes, or references, a geographic location such that any data item having such a reference can be displayed in correlation with any other data item having such a reference. For example, a data item (e.g., a transmission line pole structure) from a CAD file in the “Design Data” database has an associated location within that file (e.g., a distance and elevation from a specific reference point in the file), with a geographic location reference defined for that reference point. That pole structure's geographic location can thus be translated into a common geographic coordinate format, such as the WGS84 world longitude/latitude coordinate format as described above. And, a high-resolution terrain map image in the “Base Map Data” database includes associated geographic location information that can likewise be translated into WGS84 Format. Thus, the two items can be displayed in proper geographic correlation using the Geographic Information System (GIS) 31c application as described above.

Looking to the “Design Data” database server 32, data within those databases generally includes engineering and design data related to the project grouped into “engineering design”, “surveyed data”, “routing”, and “environmental data”. “Design Data” is generally data and/or information created by the project manager in the design and development of the transmission line construction project, as opposed to pre-existing data such as terrain data or historical databases.

“Engineering Design” data includes the Computer Aided Design (CAD) data files having the construction project design, including object and feature information for structural components of the project (e.g., a transmission line pole is 150 feet tall). In this exemplary embodiment, the CAD files are from any appropriate construction project design applications or tools, such as Powerline® Systems, Inc.'s PLS CADD™ for overhead transmission line design, and Bentley's MicroStation for underground transmission line design.

“Surveyed Data” includes information relating to project boundaries, elevations along the route of the project, and projected and actual encroachment of the project into existing properties. In this exemplary embodiment, the “surveyed data” files are typically AutoCAD® files.

“Routing” data includes information defining right-of-way routes for the project, typically defined as a centerline and two boundary lines. Routing data includes access road information, which will appear on the geospatial project dashboard user screen as shading to indicate the location of the road. Using the project management and scheduling application 31 a, users are able to search the database for access roads and generate driving directions to that road. The routing data is typically in AutoCAD® format, and may also, or alternatively, be included as part of the “Surveyed Data”, or considered a subset of the surveyed data.

“Environmental Data” includes data relating to environmental issues for any of the properties included in the construction project, such as identification of protected wetlands (either state-identified or surveyed by the project manager), identification of protected plants or animals, and identification of rock content on property. Information and data in the environmental data database can be pre-existing information obtained from third parties, or may be data acquired by the project manager through manual surveys of the construction route.

Looking next to the “Status Inputs” database server 34, data within those databases primarily includes data generated by the project manager, grouped generally into “environmental”, “field supervisors”, “real estate”, “customer relations”, “field inspectors”, and “vegetation control.” Changes and inputs to the “Status Inputs” database are made primarily using the Primavera® project management software application discussed above.

“Environmental” data includes information related to environmental issues such as identification of wetlands, identification of contamination, identification of soil types, etc. This environmental information is generally supplemental to the environmental data discussed above with respect to the “Design Data”, and includes primarily information gathered by the project manager as the result of input from field crews, field supervisors, or site surveys rather than pre-defined environmental information obtained from third parties.

“Field Supervisors” data includes project status updates provided by field supervisors based on their records of the status of various aspects of the transmission line construction project.

“Real Estate” data includes information primarily related to the acquisition of property, or of property rights, for the transmission line construction project. The data may include information as to the status of offers for acquiring various parcels of properties, the status of obtaining agreements relating to encroachments on properties (e.g., easements), and any other information related to the properties affected by the construction project, such as access roads on the property, encroachments, engineering issues, and linked documents (e.g., deeds, side letters, etc.). Real estate data is typically grouped according to property parcel or address identification.

“Customer Relations” data includes information relating to issues raised by property owners affected by the construction project. For example, a property owner may have a concern about the transmission line construction project jeopardizing a particular tree on the property. That issue is entered (usually by a customer relations representative, as described above) into the customer relations database, with the issue associated with the particular property affected.

“Field Inspectors” data includes information relating to the construction project or properties observed by field inspectors based on their inspection of the construction project or issues with properties affected by the construction project. Note that field inspector data may overlap significantly with the field supervisors data.

“Vegetation Control” data includes information relating to trees, brush, and other vegetation on properties affected by the construction project that needs to addressed in order to proceed with the project. For example, field crews may note that brush needs to be cleared before installation of a transmission line pole foundation can be started.

Looking to the “Vector Source Data” database server 36, the data within those databases includes “historical/cultural” data, “wetlands/fauna/flora” data, and “boundaries” data. The data in the “Vector Source Data” database is primarily static data (i.e., data that is not updated during the course of the construction project), and comprises pre-existing databases having information relating to properties affected by the construction project.

“Historical/Cultural” data includes information relating to burial grounds, historic properties, etc. This data is usually obtained from government information services and is typically in the form of a GIS data file.

“Wetlands/Fauna/Flora” data includes information relating to designated wetland areas and the plants and animals within those areas. This data is usually a CAD file obtained from government information services.

“Boundaries” data includes information relating to towns, counties, zip code areas, and other pre-defined regions.

Looking to the “Base Map Data” database server 38, the data within those databases includes “High Resolution Imagery” and “High Precision Terrain” groups, each of which comprise image data (e.g. satellite, aerial, and other actual views of the land) and/or elevation data. Terrain data is typically raster data, usually in the form of points having an x, y, and z coordinate, with the x and y coordinates representing a latitude/longitude location and the z coordinate representing an elevation. This base map data is typically static in that it is not updated daily, although periodic updates to the imagery may be obtained by the project manager over the course of the construction project. The “Base Map Data” is used primarily by the Geographic Information System application 31c to provide a “background image” view of the actual terrain encompassed by the construction project, with other construction project data overlaid onto that image (as color-coded features, icons and/or text) so that the overlaid project data appears visually in its proper geographic location with respect to the terrain.

“High Resolution Imagery” data is typically custom imagery data acquired by the project manager specifically for the construction project. This image data usually includes only areas encompassed by the construction project (or portions of the construction project), and may be obtained by contracted fly-over aerial photography of the construction site.

“High Precision Terrain” data is typically non-custom, pre-existing, commercially available terrain data of various geographic areas. While this imagery data includes the properties and areas encompassed by the construction project, the imagery is not specific to the construction project and typically includes data outside of the areas covered by the construction project.

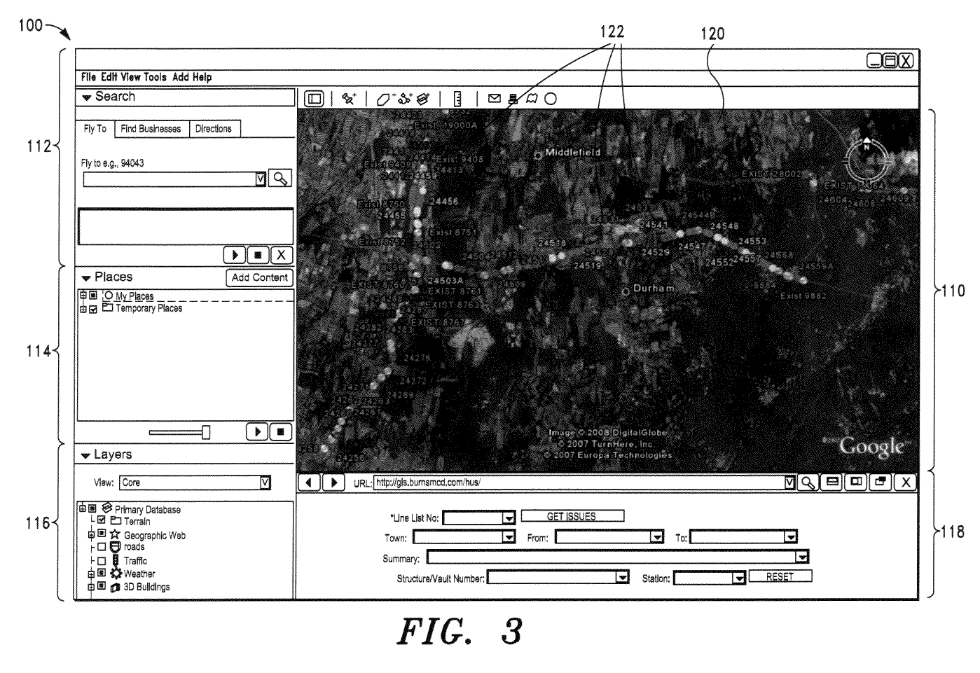

With the general configuration of system 10 set forth above, the overall operation of the system in managing a transmission line construction project, and providing a geospatial project dashboard user screen displaying the aggregated construction project data and terrain data, will be described with reference to FIG. 3. Looking to FIG. 3, a “screen capture” of a geospatial project dashboard user screen generated by system 10 is depicted generally as numeral 100. User screen 100 comprises a geospatial information display window 110, a search window 112, a places window 114, a layers window 116, and an embedded web page window 118.

Embedded web page window 118 is simply an ASP.NET web page that can be opened or closed by the user as desired. When closed, the geospatial information display window 110 will appear larger and fill the entire user screen. When open, a user can use the web page to access various user input screens of the applications running on application server 30. As will be described later with respect to various exemplary methods in accordance with the present invention, the embedded web page window 118 can be used to access various user screens of the project management and scheduling application, with links to the GIS application allowing a data item in the embedded web page (e.g., a property address or other geographic location identifier) to be transmitted to the GIS application such that the GIS application will move and/or zoom to the corresponding location. Thus, a user can simultaneously access data from the databases using the embedded web page window 118 while viewing terrain and construction project images generated by the GIS application in the geospatial information display window 110.

As will be apparent to those skilled in the art, geospatial information display window 110, search window 112, places window 114, and layers window 116 are part of the Geographical Information System (GIS) application 31c of system 10 of FIG. 1. As described previously, in this exemplary embodiment the GIS application is Google® Earth Professional. Thus, the search window 112, places window 114, layers window 116, and geospatial information display window 110 are part of the Google® Earth application and function as is known to those skilled in the art. The GIS application accesses one or more of the KML (or KMZ) data files generated by the translation application 31b as previously described, and displays the construction project data features defined within those KML files as color-coded representative images, icons, and/or text in the geospatial window 110 of the user screen as will be described in more detail below.

As part of the GIS functionality, search window 112, places window 114, and layers window 116 work in conjunction to control the display in the geospatial information window 110. For example, a user can use the search window 112 to enter a geographic location (e.g., a zip code, a street address, etc.) which locates the display in the geospatial information window 110 to that geographic location.

Using the places window 114 and layers window 116, the user can select various information for display in the geospatial information window 110. In this exemplary embodiment, the KML files generated by the translations application are accessible/selectable by the user through places window 114, with the base map data database information (i.e., terrain data) being accessible/selectable in layers window 116. As is known in the art, the places and layers windows allow a user to access folders on the system, and then individually select or deselect files for inclusion in, or exclusion from, the display in geospatial information window 110. Thus, a user can customize the amount of information displayed in the geospatial information window 110.

Looking to the geospatial information window 110, in this exemplary embodiment, terrain data 120 is displayed as a “background” image, with features (color-coded images, icons and/or text), indicating various construction project components and/or issues, and the status of that component or issue, overlaid on the background image. As described previously, the terrain data or background image information is stored in the “Base Map Data” database, and accessed by the GIS application, with the features being embedded in the KML data files and generated from the “Design Data”, “Status Inputs” and “Vector Source” database as previously described. In an exemplary embodiment of the present invention using Google® Earth Enterprise as the GIS application, the construction project data may be fused into the Google® Earth Enterprise database, without the use of KML files.

As can be seen, the view in geospatial information window 110 provides an overview of a geographically-expansive transmission line construction project. Structural components, issues, and features of the project, represented as color-coded icons and text, are displayed in correlation with a background image (e.g., terrain data) such that the correct geographical location of those structures, issues, and features can be easily ascertained by a user. With the color-coding of the displayed features providing information representing the status of each of corresponding structure, customer relations issue, or other construction project data, a project manager viewing the “geospatial project dashboard” user screen as shown in FIG. 3 can quickly view and ascertain the overall status of the entire construction project. And, as will be more apparent in the description of exemplary methodologies of using the system described below, the project manager can use the geospatial project dashboard to zoom in to view more detailed views of the project, and to click on the displayed feature to obtain more detailed information relating to the construction project data item represented by that feature.

With the system thus set forth, an exemplary methodology of managing various aspects of a geographically-expansive transmission line construction project will now be described with reference to that system. The methodology will be described in conjunction with various “screen capture” depictions of user screens associated with the applications running on the system as set forth above, and with respect to various exemplary inputs and inquiries to the system. It should be understood that the system of the present invention lends itself to innumerable variations of use. Thus, the examples presented are not limiting, but simply exemplary in nature. Other methods of use, and uses in different sequences or specific applications than those described herein, will be apparent to those skilled in the art and are within the scope of the present invention.

### Methodology of Managing a Geographically-Expansive Construction Project

An exemplary method of managing a geographically-expansive transmission line construction project will be described with respect to various aspects of the project and examples of use of the system, including examples related to overhead line construction, underground line construction, and customer relations issues.

In one aspect of managing a geographically-expansive transmission line construction project, the “underground” portion deals with the construction of underground transmission lines and the structures involved in that construction, such as vaults, hand holes, and duct banks. A project manager, using the system of the present invention, can manage and view the status of the construction project on a geospatial project dashboard user screen. As construction progresses, field supervisors can update the status of each structure using the project management and scheduling application. The color-coded status of each structure is displayed as features on the geospatial project dashboard user screen. Thus a user can quickly ascertain the status of any particular structure by viewing the color-coded feature corresponding to that structure. Additionally, a user can view and ascertain the overall project status by simultaneously viewing the features for all of the project's structures on the geospatial project dashboard user screen.

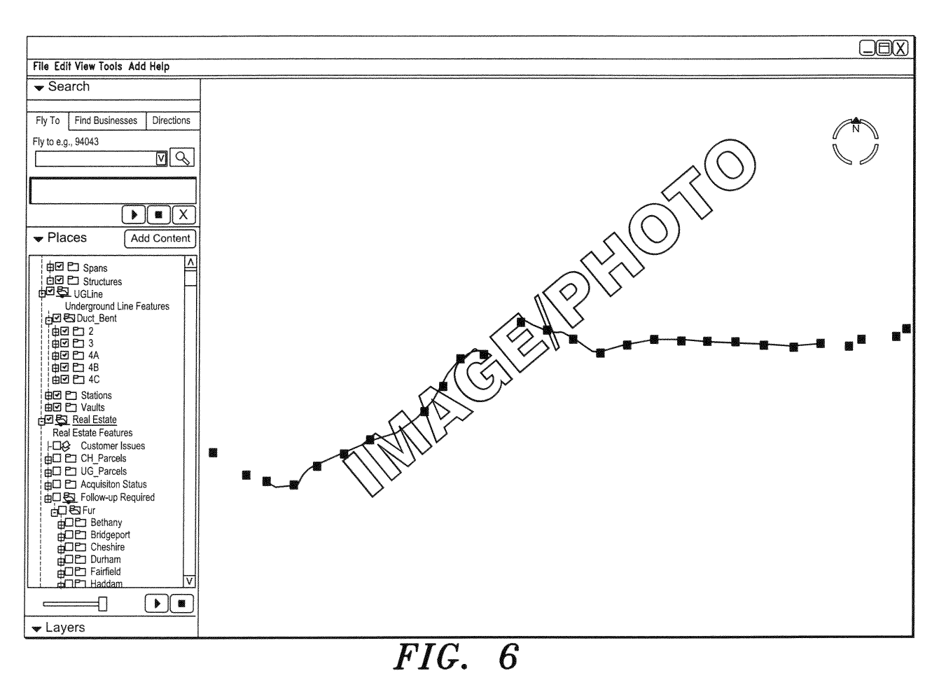

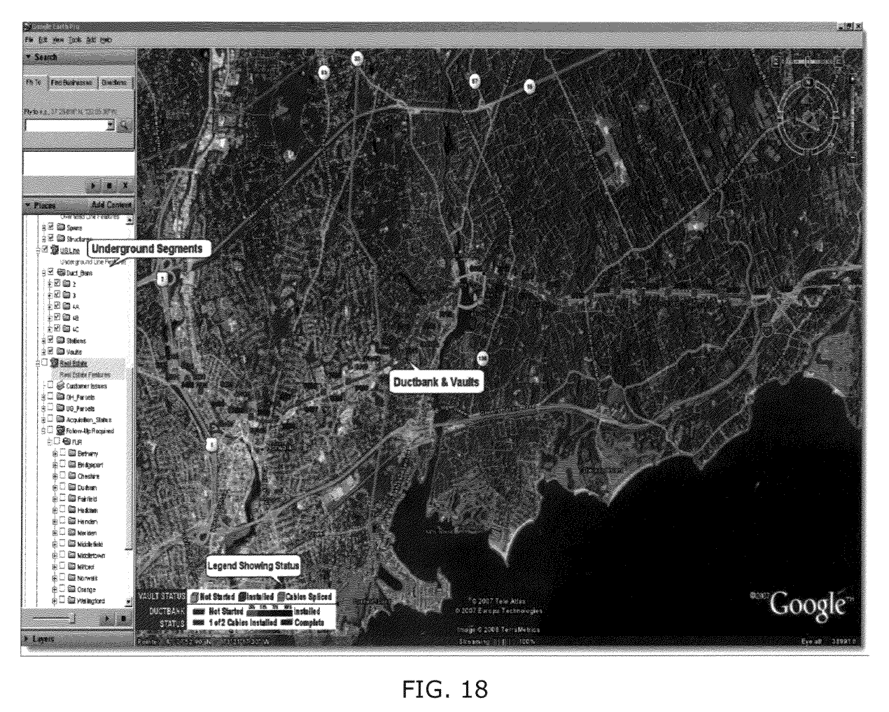

As described previously, design details for the underground portion of the transmission line project are in one or more CAD files, typically MicroStation DGN or Auto CAD® files. Those design files include geographic location information for every structure within that design file that allows the geospatial computer system (as described above) to display features representing those structures in conjunction with a background image (e.g., terrain data) on a geospatial project dashboard user screen. As shown in FIGS. 6 and 18, a project manager can view every underground structure (e.g., vaults duct banks, and hand holes) for an entire geographically-expansive transmission line construction project on a single user screen, with the locations of those structures shown with respect to their actual physical spatial location against the underlying background image (e.g., terrain data). As can also be seen, the color-coded features associated with each structure readily identifies the construction status of that structure. The features include a text portion comprising an identification tag (i.e., a number) that uniquely identifies that structure within the system, and an icon portion that indicates the type of structure (i.e., a vault). Looking to FIG. 18, the various color-coded features represent the various structures and their status, presented in their proper geographic location against a background image (e.g., terrain data).

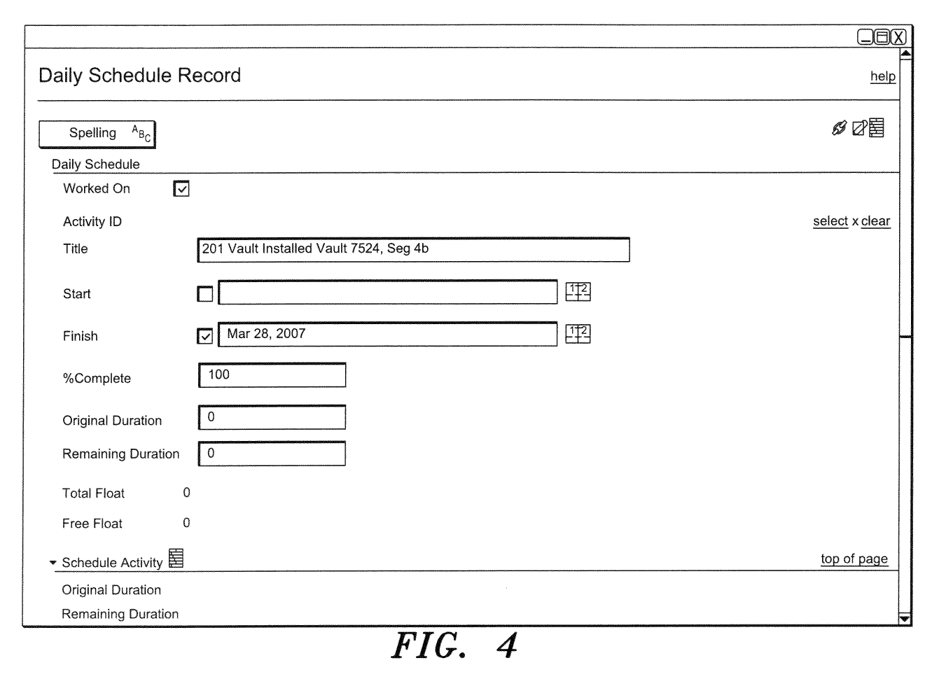

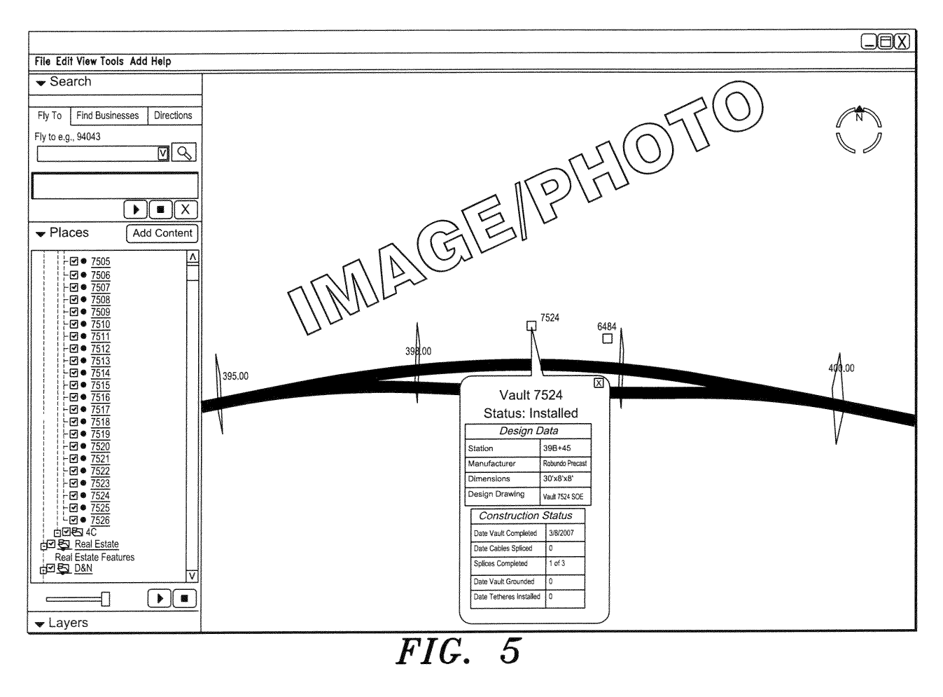

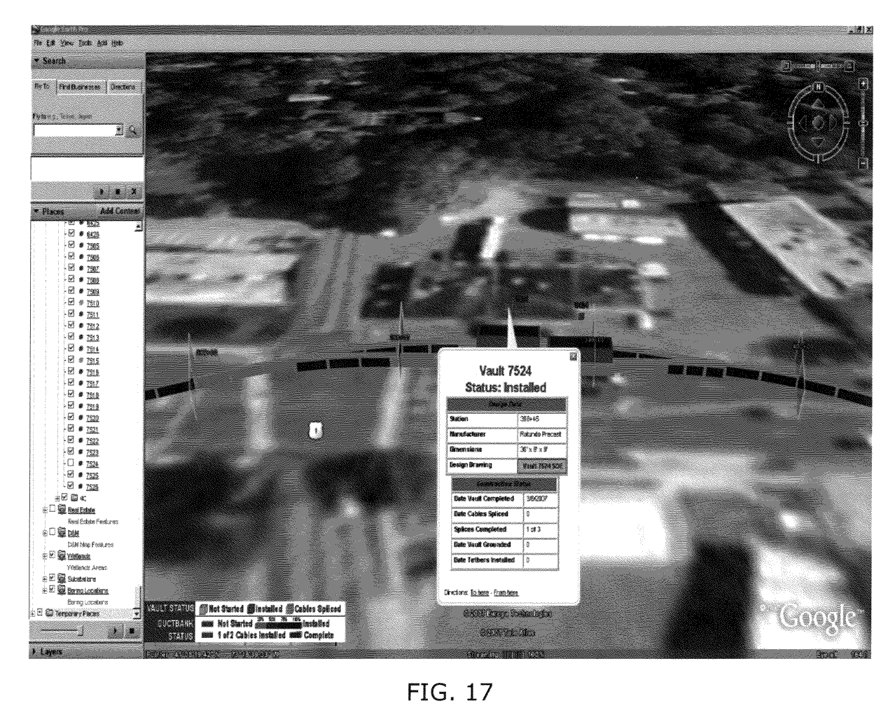

Looking to FIG. 4, a “daily schedule record” screen provided by the project management and scheduling application is depicted. A field supervisor, upon completion of installation of a vault (in this example), enters that completion status into the project management and scheduling application, which in turn stores that data in the appropriate system database, as described above. When the geospatial computer system generates its next KML data files (as described above) the updated information with respect to that vault's installation is reflected in the KML file. Thus, looking to FIGS. 5 and 17, the next time the construction project data relating to that vault is displayed, the geospatial project dashboard displays the current status of that vault, with the color of the feature for that vault indicating the completion status. As can be seen in FIGS. 5 and 17, with the user's viewing angle (or camera angle) set to a perspective view, the representative image of the vault features appear as three dimensional images against the background image so that a user has an apparent “actual” view of the vault structures (such a three-dimension box) of the construction project in their actual geographic location

As also seen in FIGS. 5 and 17, a user can obtain more detailed information regarding any construction project data item by clicking on, or hovering over, the displayed feature representing that data item. As can be seen in the example user screen, clicking on the displayed feature corresponding to the vault having identification tag 7524 causes a pop-up information window to display, with that window providing more detailed information related to that vault. As can also be seen, the detailed information displayed correlates to the construction completion status entered by the field supervisor as previously described with respect to FIG. 4. As is also apparent in FIGS. 5 and 17, the geospatial project dashboard can provide a zoomed (in or out) and/or a perspective view by using the zoom and camera tools of the geographical information system (GIS) application, as is known in the art.

As will be apparent to those skilled in the art, the above description of displaying a feature representing a vault structure, updating its construction status, and obtaining detailed information for that structure by clicking on (or hovering over) its displayed feature, is applicable to other structures and components related to managing a geographically-expansive construction project. For example, any of the information stored in the databases of system 10, as described above, can be viewed in relation to its geographic location, with more detailed information being available by zooming to the feature displayed for that data item, and by selecting or hovering over the feature associated with that item. In the case of structures, more detailed plan designs are viewable. In the case of properties, any information and/or documents associated with that property record are viewable. In the case of customer relations issues, more detailed information regarding that issue is viewable.

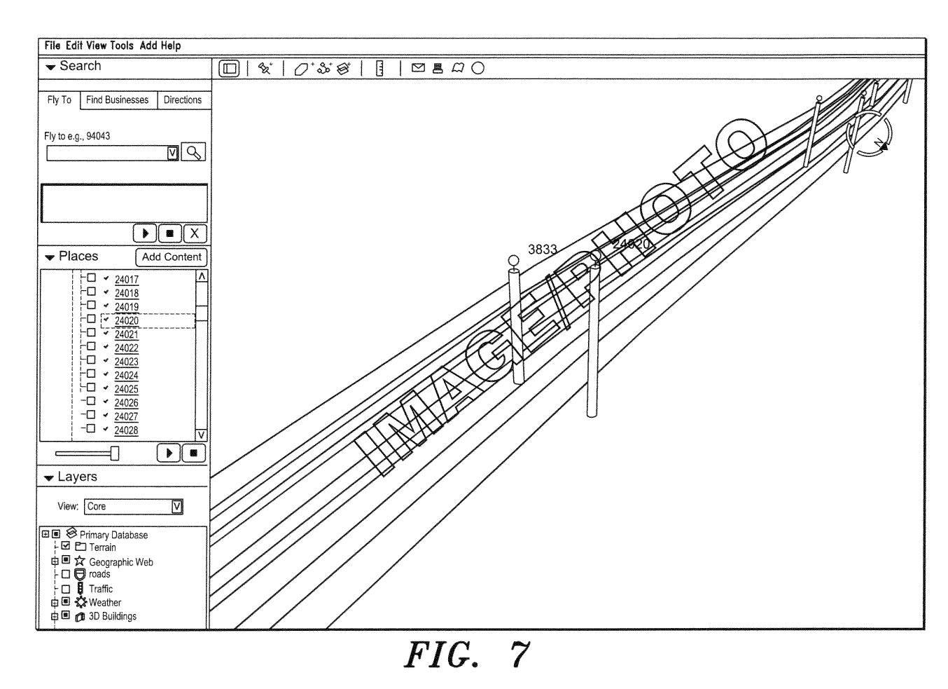

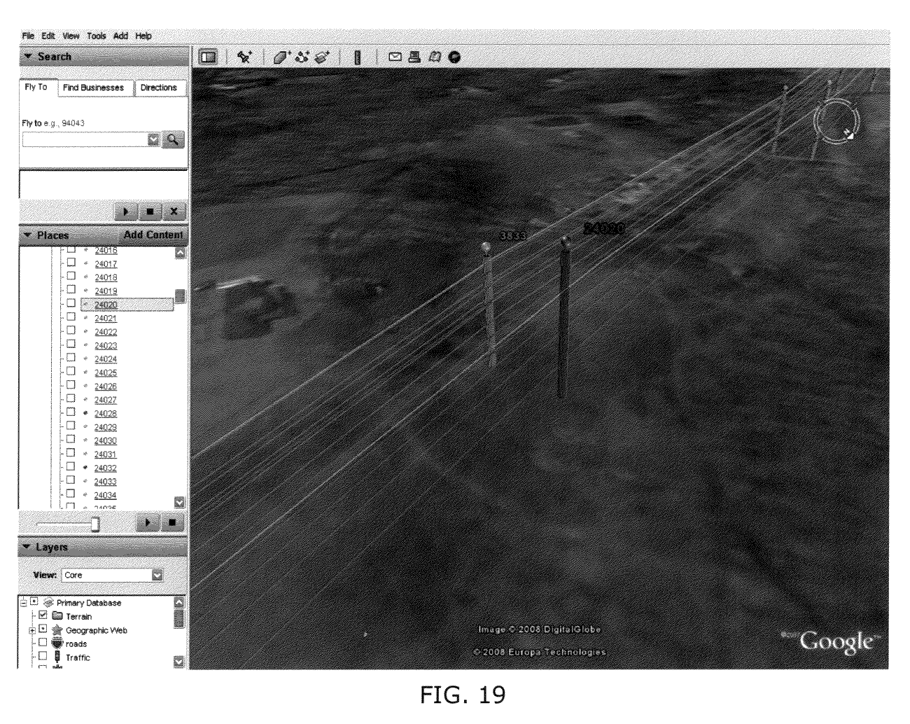

In another aspect of managing a geographically-expansive transmission line construction project, the “overhead” portion deals with the construction of overhead transmission lines and the structures involved in that construction, such as poles, foundations, and wires. As described previously, design details for the overhead portion of the transmission line project are typically stored in one or more PLS-CADD files. Those design files include detailed design information, along with geographic location information for every structure in that file. The geographic location information is used by the geospatial computer system (as described above) of the present invention to display those structures on a geospatial project dashboard user screen in conjunction with a background image (e.g., terrain data) such that those structures appear in their correct geospatial location. As seen in FIGS. 7 and 19, a “screen shot” of an exemplary display of overhead transmission line structures includes features (comprising color-coded images, and/or icons, and/or text) representing poles and wires. The poles have style attributes so that their features appear as vertical poles extending from the terrain, and with the features representing the wires having attributes such that they appear as wires positioned at the proper elevation from the terrain. As can be seen in FIGS. 7 and 19, with the user's viewing angle (or camera angle) set to a perspective view, the transmission pole and lines appear as three dimensional images against the background image so that a user has an apparent “actual” view of the structures of the construction project in their actual geographic location.

As also seen in FIGS. 7 and 19, the text portion of the feature includes an identification tag. The identification tag is a unique identifier for that structure that allows all information in any of the databases to be correlated with that structure, such as detailed design drawings, specifications, and the like.

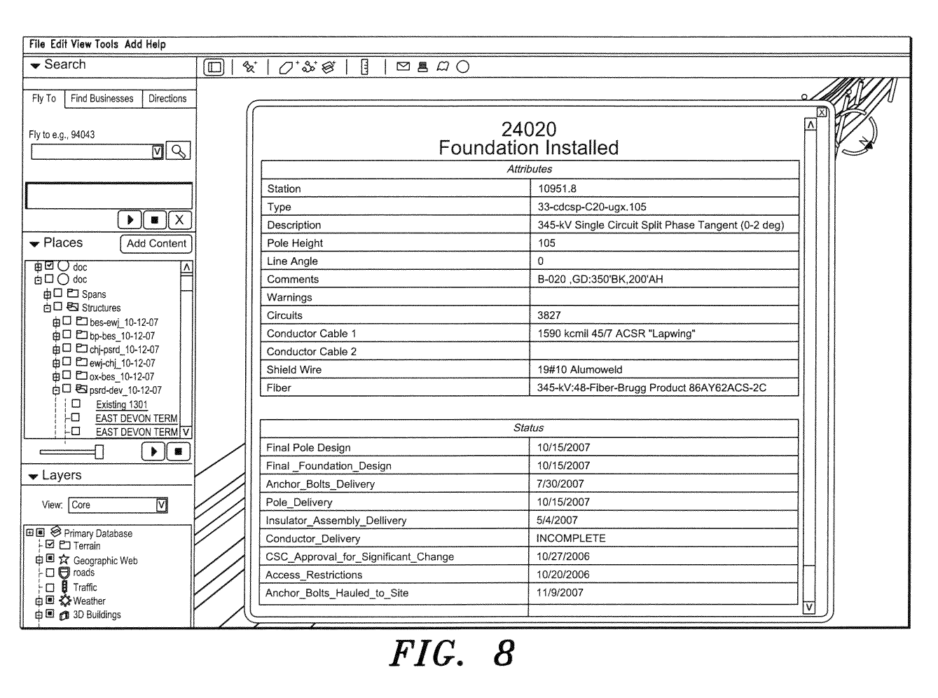

In a manner similar to that described previously for the vault installation, clicking on the pole feature “(i.e., pole “24020”) causes a detailed information window to display, as shown in FIG. 8. As seen in FIG. 8, the information window provides detailed information related to the construction status of that pole. A project manager, viewing the pole installation in its correct geographic orientation on the geospatial project dashboard user screen as shown in FIGS. 7 and 19, can thus obtain detailed status information (as shown in FIG. 8) for any structure viewable in the geospatial project dashboard user screen. When finished viewing the detailed information window, the project manager can simply close that window and return to his previous position in the geospatial project dashboard user screen.

As is apparent in FIGS. 7 and 19, the geospatial project dashboard user screen displays the features in a manner that allows a project manager to view the status of the entire construction project, or to view just a portion of the construction project by using the zoom and camera features of the geographical information system (GIS) application. As is also apparent in FIG. 19, the construction status of any structure can be ascertained by the color of the displayed feature for that structure.

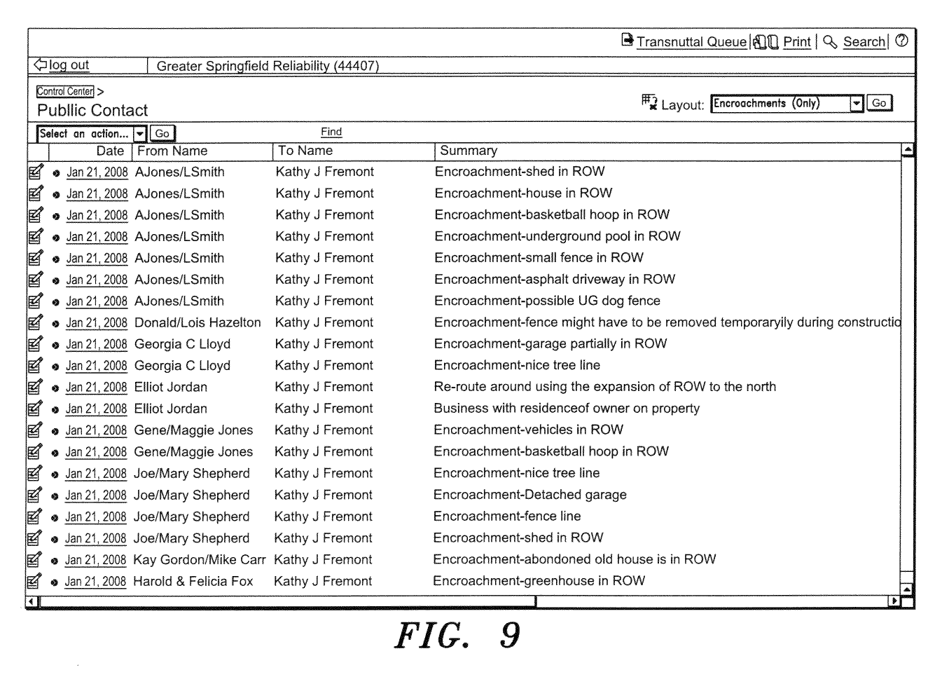

Looking now to FIGS. 9-16 and 20-24, in another aspect of managing a geographically-expansive transmission line construction project, the customer relations portion deals with issues arising from the transmission line construction project crossing over, through, or near numerous properties, each of those properties being owned by different entities. As described previously, the “real estate” and “customer relations” databases store information related to properties affected by the construction project. For example, a property owner with an issue regarding the construction project can contact a customer-relations representative, who in-turn can enter that customer's issue into the appropriate database(s) using the project management and scheduling application. With the issue being associated with a particular property, and with that particular property having geographic location information, that issue can thus be displayed on the geospatial project dashboard user screen in a manner similar to that just described with respect to the display of structures related to the construction project.

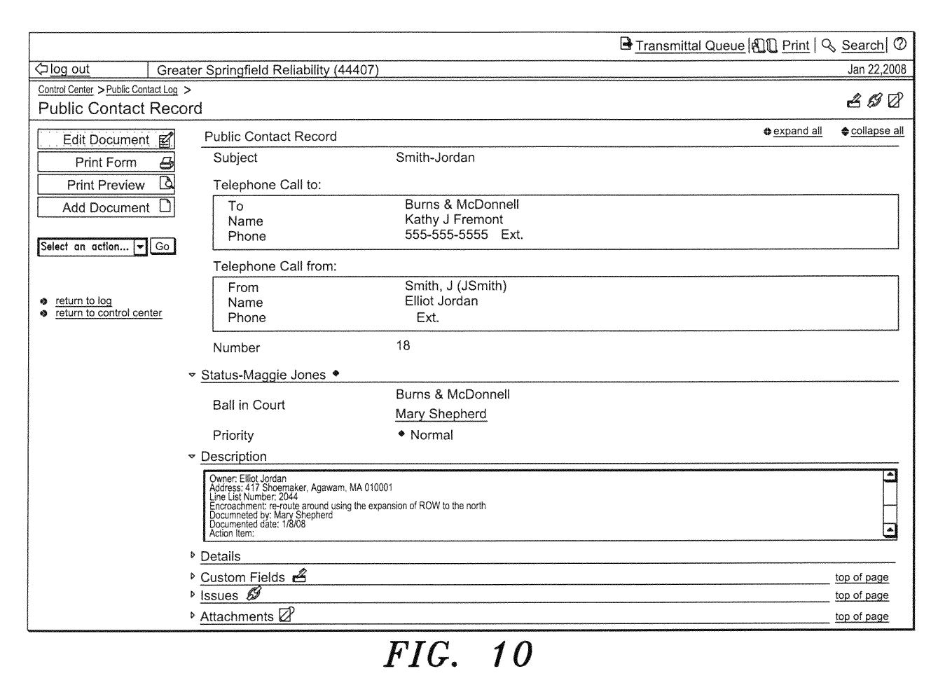

Looking first to FIG. 10, a “public contact record” data input screen provided by the project management and scheduling application is depicted. The public contact record screen allows a customer-relations representative to log a contact with a property owner (in this case, a telephone call) and note the affected property address, the property owner's name, the nature of the issue (e.g., encroachment), and any other pertinent information into the customer relations database. As also seen in FIG. 10, each customer relations issue is assigned a “line list number” (in this case, “2044”) which serves as an identification number for that concern or issue for storing and accessing that data item in the database. Line list numbers are typically assigned to track the path of the construction project, for example the line list numbers may increase sequentially along the path of the project from south to north.

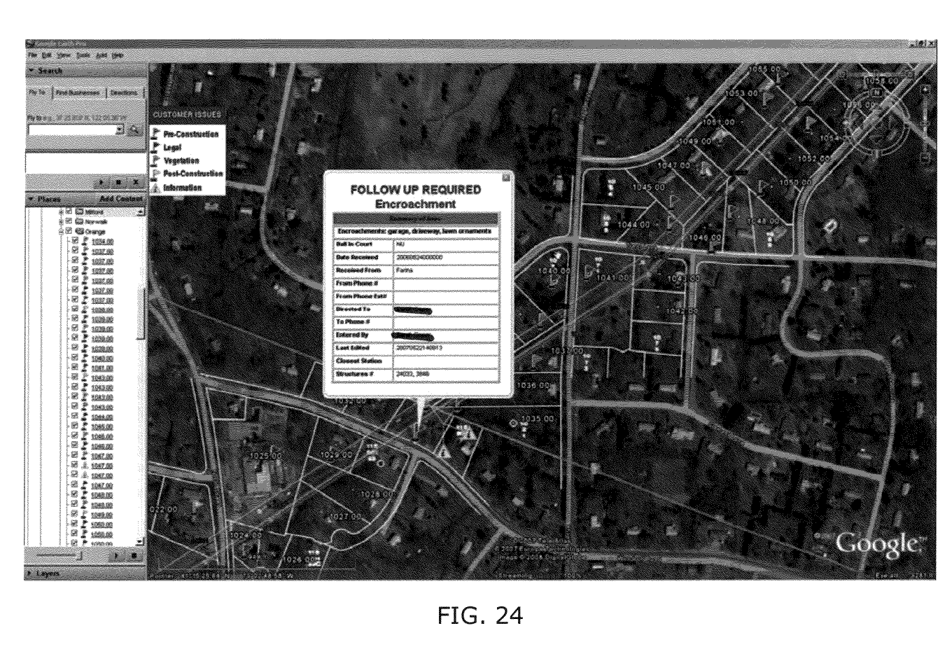

The property address entered in association with logging the property owner's issue provides geographic location information for displaying that concern on the geospatial project dashboard. As described previously, system 10 provides translation of geographic location information so that an address, such as the property owner's address, can be located and displayed on the geospatial project dashboard user screen. Looking to FIG. 24, features representing customer relations issues comprise flag icons displayed in the correct geographic location on the background image (e.g., terrain data). The color of the feature (flag icon and text identifier) indicates the status of the concern, with red indicating a pre-construction status, blue representing a legal issue, green indicating a vegetation issue, and yellow indicating a post-construction issue. As seen in FIG. 24, in a manner similar to that described with respect to the display of structures, clicking on a customer relations feature (i.e., flag icon) causes a detailed status window to pop-up. Thus, a user can view detailed information related to any displayed customer relations issue by clicking on the feature representing that issue displayed on the geospatial project dashboard user screen.

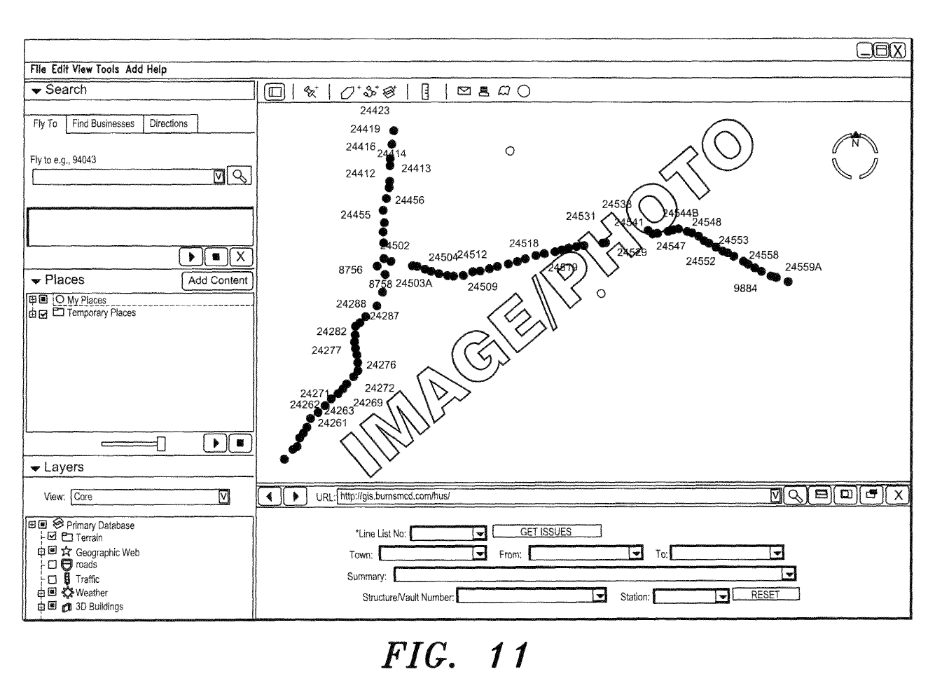

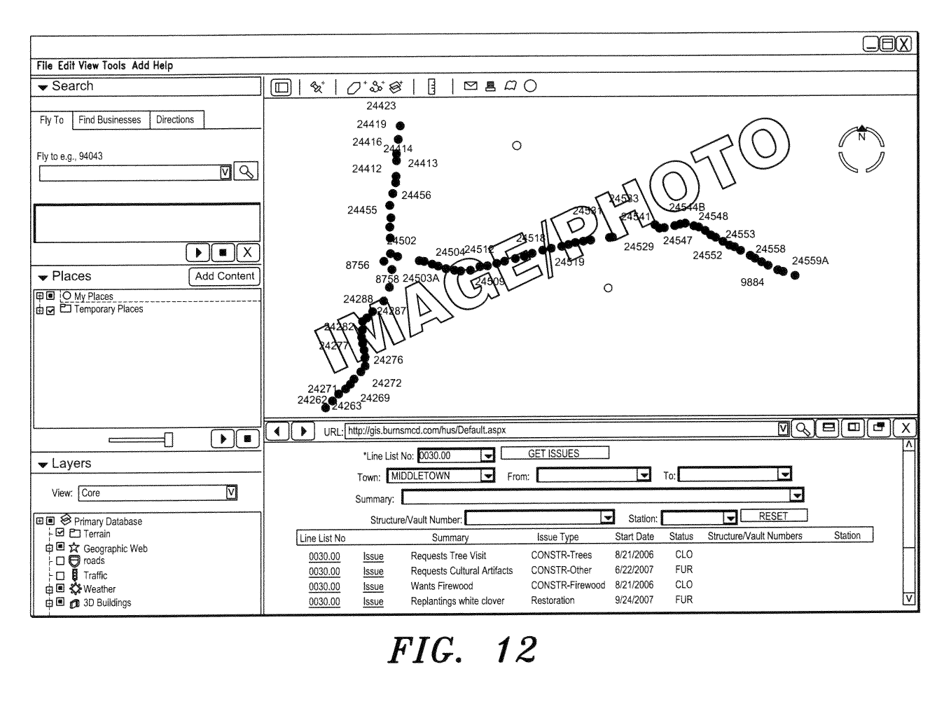

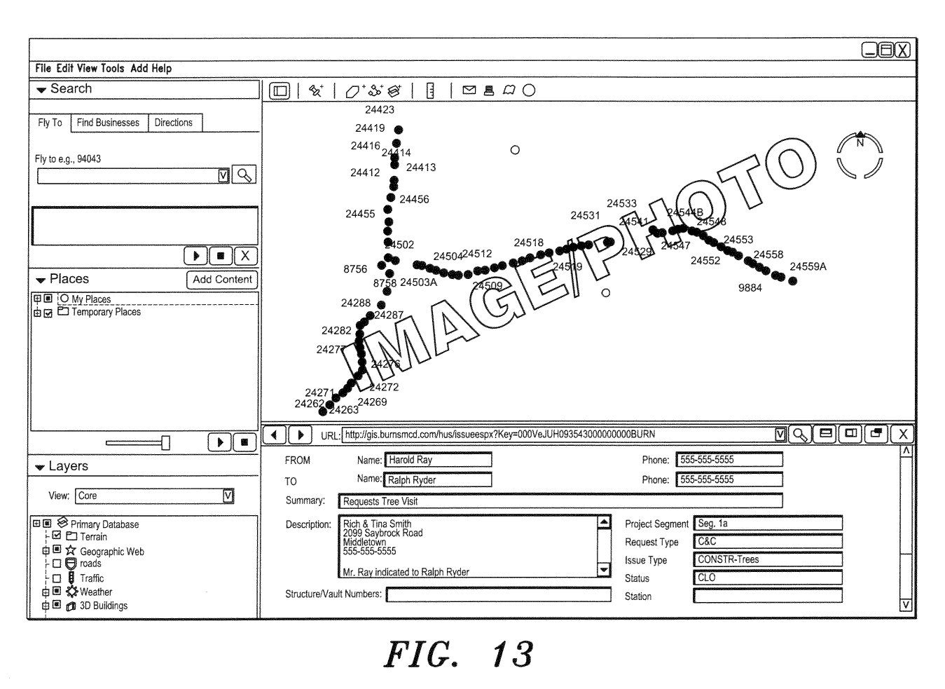

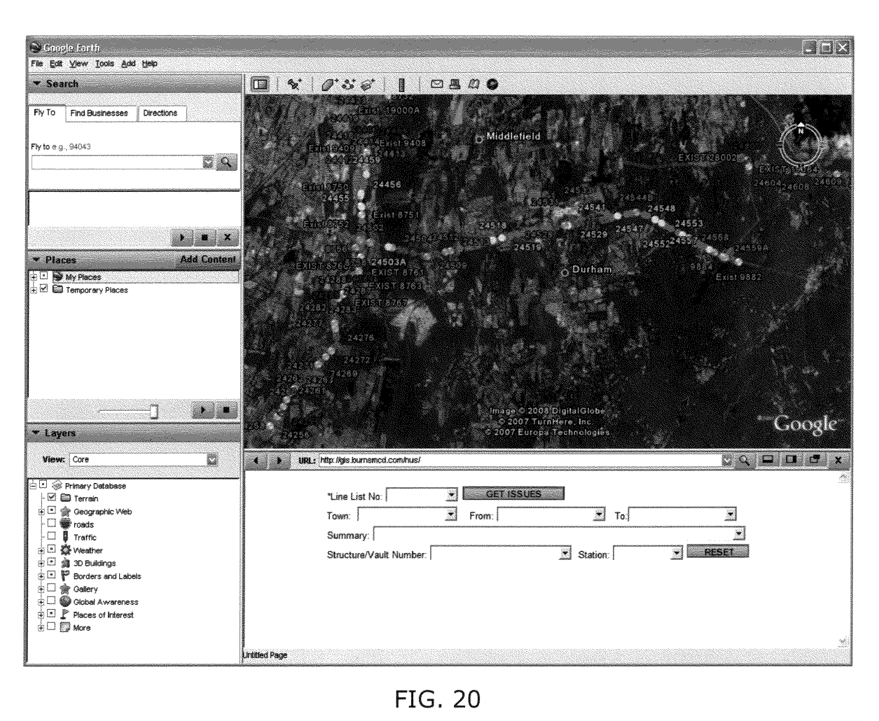

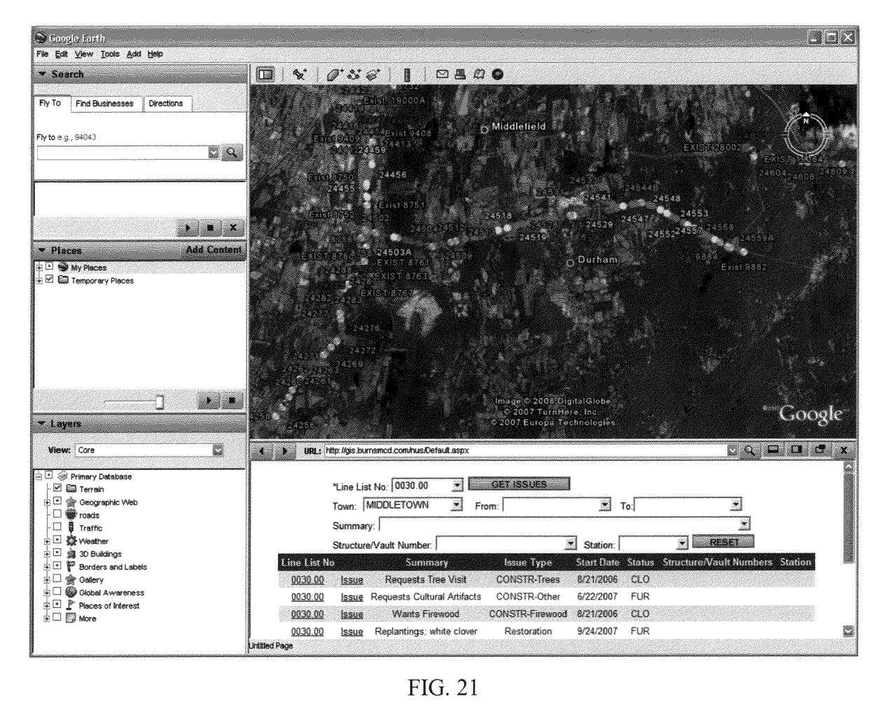

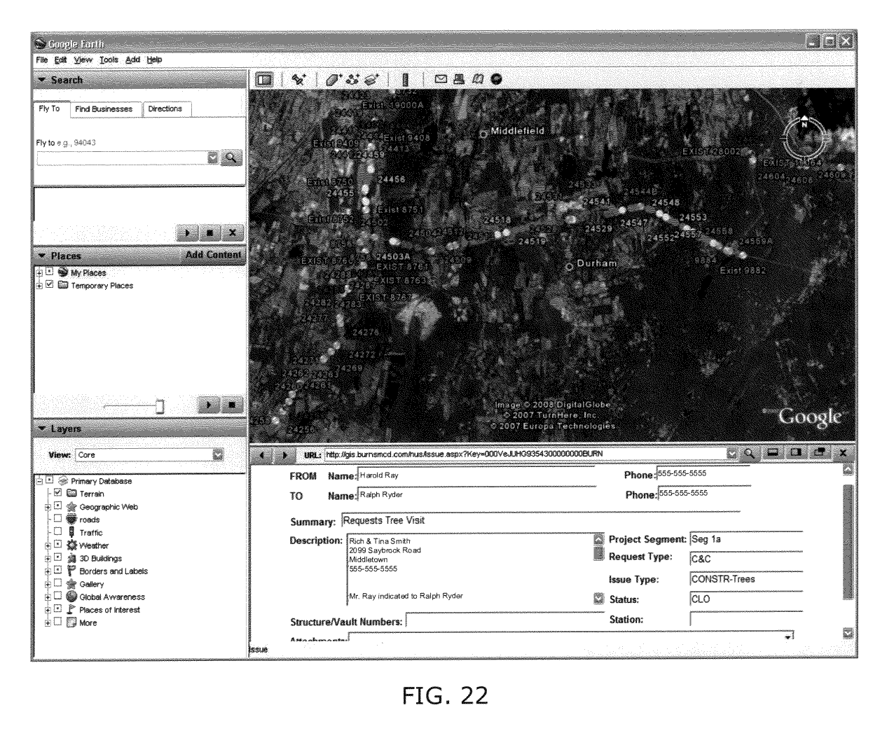

Looking to FIG. 11, as discussed briefly above, the embedded window feature of the display screen can be used to access and view user screens available from the project management and scheduling application (or any application running on the system), to access the databases of the system, and to navigate the geospatial information window to a location indicated in the embedded window. As seen in FIGS. 11 and 20, a data inquiry screen for searching customer relations issues is presented. Looking to FIGS. 12 and 21, selecting, for example, a line-list number from the “line list” data input box menu causes the project management and scheduling application to display all issues associated with that line list number. As will be apparent to those skilled in the art, other input boxes in the inquiry screen allow a user to search or filter by other criteria. Upon selecting one of the located and displayed issues (in this example, the first listed “Request Tree Visit” issue), the project management and scheduling application then displays more detail related to that issue, as depicted in FIGS. 13 and 22

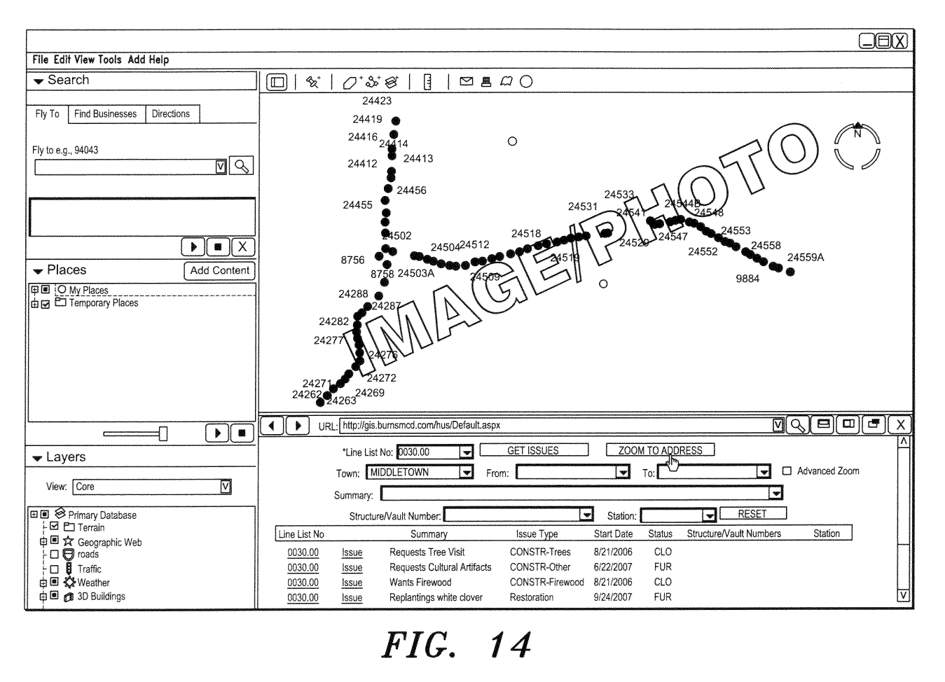

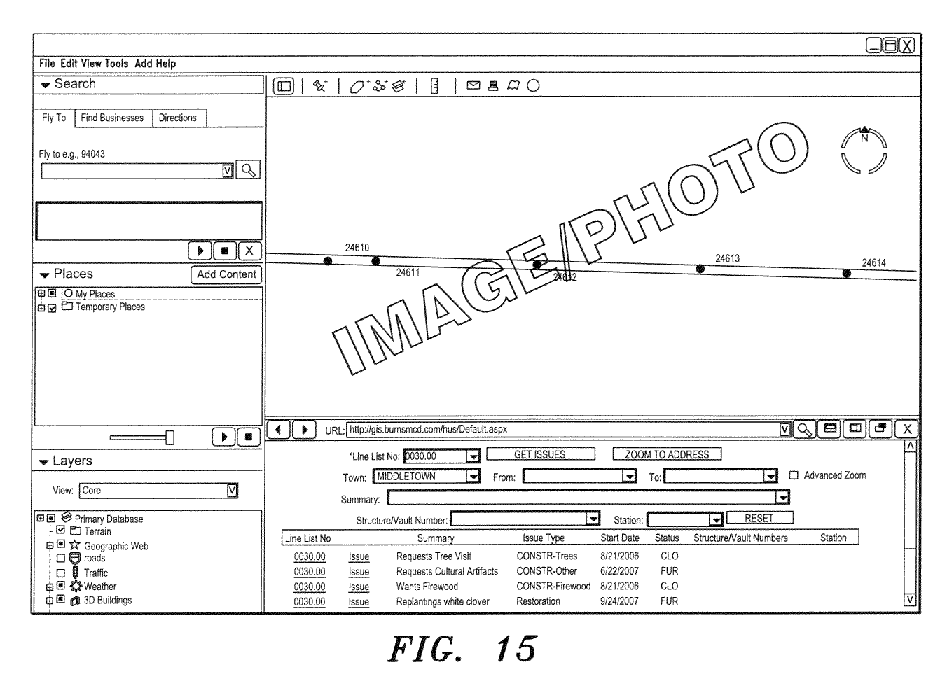

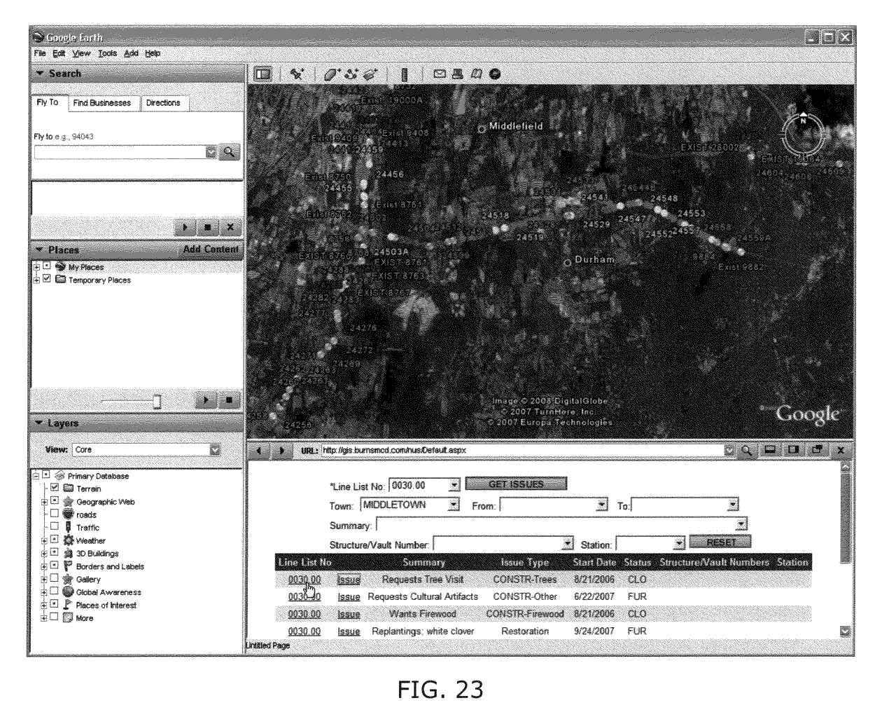

Looking to FIGS. 14 and 23, with issues relating to a particular property displayed, selecting the “Zoom to Address” button causes the embedded window to transmit a command to the geographic information system (GIS) application, which in turn zooms the view in the geospatial information window to the desired address (i.e., the address of the property associated with the issued displayed in the embedded window). As seen in FIG. 15, the view in the geospatial information window has been zoomed to view the geographic area corresponding to the address of the customer relations issues displayed in the embedded window of FIG. 14 in response to the user clicking the “Zoom to Address” button.

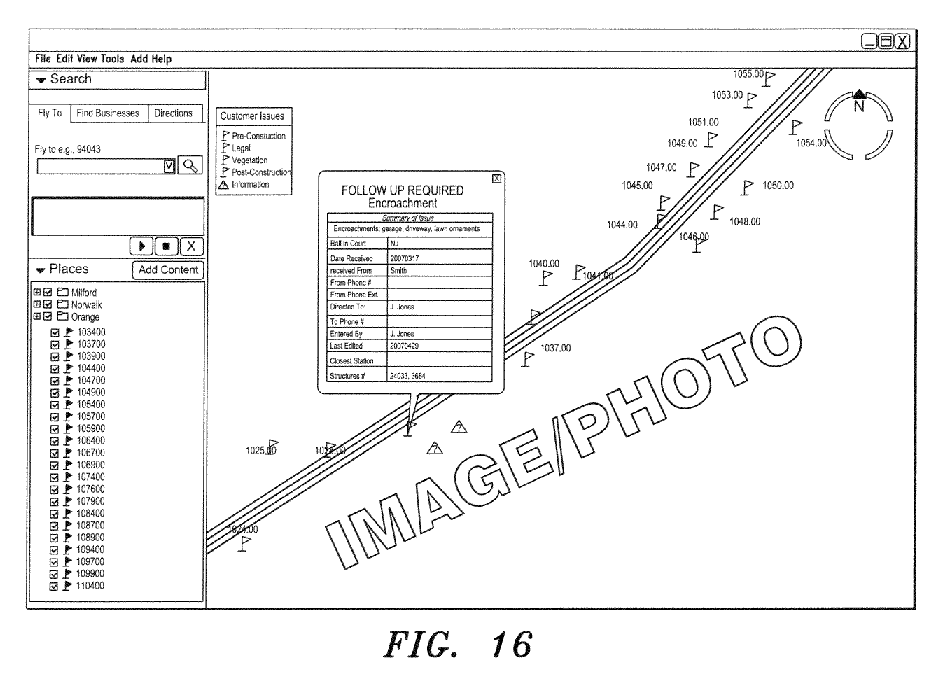

As shown in FIGS. 16 and 24, and as described briefly above, features for customer relations issues display as a flag icon and an associated text identification tag, with color-coding of the feature indicating the status of the issue as described above. In a manner similar to that described above with respect to the display of structures, clicking on a customer relations flag feature causes a detailed status/information window to display. In the example shown in FIGS. 16 and 24, the information window indicates that the selected customer relations issue requires a follow-up by the project manager. As can be seen, a user can view detailed information related to any displayed customer relations issue by clicking on the corresponding feature displayed on the geospatial project dashboard user screen.

As described herein, it can be seen that the present invention provides an intuitive, easy-to-use system and method for managing a geographically-expansive transmission line construction project. While the present invention has been described and illustrated hereinabove with reference to an exemplary embodiment and exemplary methods, it should be understood that various modifications could be made to this embodiment without departing from the scope of the invention. Therefore, the invention is not to be limited to the specific embodiment described and illustrated hereinabove, except insofar as such limitations are included in the following claims.

What is claimed and desired to be secured by Letters Patent is as follows:

1. A computer-implemented method for managing a geographically-expansive construction project; comprising:
reading a plurality of construction project data from a database, wherein at least a portion of said construction project data includes first geographic location information;
retrieving terrain data from the database, wherein said image data includes second geographic location information; and
displaying to a user said construction project data in conjunction with said image data such that said construction project data appears in a correlated geographic location with said image data so as to enable management of the construction project.

2. The computer-implemented method of claim 1, wherein said database comprises a plurality of databases.

3. The computer-implemented method of claim 1, wherein said construction project data in at least one of the following: project design data, project status data, customer relations data, and property data.

4. The computer-implemented method of claim 1, wherein said construction project data includes style information such that said construction project data is displayed in accordance with a corresponding style.

5. The computer-implemented method of claim 4, wherein said style information comprises dimensional and color attributes.

6. The computer-implemented method of claim 4, wherein said style information comprises a three dimensional image representative of said corresponding construction project data.

7. The computer-implemented method of claim 1, wherein said terrain data comprises project-specific terrain data, pre-existing terrain data, and combinations thereof.

8. The computer-implemented method of claim 1, wherein said displaying comprises fusing said construction project data and said terrain data.

9. The computer-implemented method of claim 1, further comprising:
viewing said displayed data to ascertain a status of at least a portion of said construction project.

10. The computer-implemented method of claim 9, further comprising:
inputting and storing updated construction project data to said first database.

11. A system for managing a geographically-expansive construction project, comprising:
a database server that stores construction project data, at least a portion of which includes first geographic location information, and terrain data, at least a portion of which includes second geographic location information; and
a server system coupled to the database server, wherein the server system:
provides a user interface that includes functionality for a plurality of users to view said construction project data in conjunction with said terrain data such that said construction project data appears in a proper geographic location correlation with said terrain data so as to enable a user to view said geographically-expansive construction project.

12. The system of claim 11, wherein each of the users comprises one of the following: a project manager, a field crew, a field supervisor, a field inspector, a customer relations representative, and a property owner.

13. The system of claim 12, wherein at least a portion of said construction project data is submitted by a user via the user interface of the server system.

14. The system of claim 12, wherein at least a portion of said construction project data is submitted by a customer relations representative in response to a request from a property owner.

15. The system of claim 11, wherein said database server is accessible to said users through said user interface such that said users can select desired data for viewing.

16. The system of claim 11, wherein said construction project data comprises at least one of the following: engineering design data, surveyed data, routing data, environmental data, real estate data, customer relations data, vegetation control data, historical data, wetlands data, field crew data, field supervisor data, field inspector data, boundary data, and image data.

17. A computer-implemented method for managing a geographically-expansive transmission line construction project, comprising:
aggregating a plurality of construction project data from a plurality of sources, wherein at least a portion of said construction project data includes geographic location information; and
displaying an aggregated image comprising at least a portion of said construction project data in conjunction with a background terrain image such that said construction project data appears in a proper geographic location with respect to said background terrain image.

18. The computer-implemented method of claim 17, wherein said displaying comprises inputting said construction project data and said terrain data into a geographical information system software application operable to create a display comprising the inputted construction project data and background terrain image.

19. The computer implemented method of claim 18, further comprising:
manipulating said graphical information system to provide varying views of said construction project data and said terrain data.

20. The computer-implemented method of claim 18, wherein at least a portion of said construction project data comprises data submitted by a customer-relations representative in response to a request from a property owner.

21. The computer-implemented method of claim 18, wherein at least a portion of said construction project data comprises data submitted by a field crew updating the status of at least a portion of the construction project.

22. The computer-implemented method of claim 18, wherein said construction project data comprises at least one of the following: design data, historical data, project manager provided data, field crew provided data, and customer relations data.

23. The computer-implemented method of claim 18, wherein at least a portion of said construction project data comprises a three-dimensional image representative of said construction project data.

24. The computer-implemented method of claim 18, further comprising:
selecting a portion of said displayed image whereby detailed information regarding the selected portion is displayed.

25. The computer-implemented method of claim 24, wherein said selecting comprises clicking on said displayed image using a computer pointing device.

26. A system for managing a geographically-expansive transmission line construction project, comprising:
a database server that stores construction project data, at least a portion of which includes first geographic location information, and terrain data, at least a portion of which includes second geographic location information; and
a server system coupled to the database server, wherein the server system:
provides a project management and scheduling application having user-input screens for accessing, viewing, and updating said construction project data;
provides a translations application operable to correlate the first geographic location information from said construction project data and said second geographic information from said terrain data; and
provides a geographical interface system application operable to display at least a portion of said construction project data and said terrain data such that said construction project data appears in a proper geographic location with respect to said terrain data.

27. The system of claim 26, wherein said construction project data comprises one or more of:
design data, real estate data, customer relations data, and combinations thereof.

28. The system of claim 26, wherein said project management and scheduling application displays user screens operable to allow a user to view, edit and update said construction project data.

29. The system of claim 26, wherein said translations application is operable to convert geographic location information from any of a plurality of first formats to a second format.

30. The system of claim 26, wherein said translations application is operable to apply display attributes to said construction project data, and wherein said geographical information system application is operable to display said construction project data in accordance with its display attributes.

31. The system of claim 26, wherein said geographical information system application is operable to allow a user to zoom-in, zoom-out, and change perspective of the viewed construction project data and terrain data.

32. The system of claim 26, wherein said geographical information system application is operable to recognize a user input with respect to a displayed project data item and to display additional construction project data in response.

33. A computer-implemented method for managing a geographically-expansive construction project, comprising:
maintaining a database comprising construction project data, at least a portion of which includes first geographic location information, and terrain data, at least a portion of which includes second geographic location information;
updating said construction project data in response to inputs from a plurality of users;
correlating said first geographic location information of said construction project data and said second geographic location information of said terrain data;
displaying at least a portion of said construction project data and terrain data in a visual format such that said construction project data appears in correlated geographic location with respect to said terrain data.

34. The computer-implemented method of claim 33, wherein said plurality of users comprises at least one of the following: a customer relations representative, a project manager, a property owner, a field inspector, a field supervisor, and a field crew.

35. The computer-implemented method of claim 34, wherein said display is monitored by a project manager to ascertain a status of the construction project.

36. The computer-implemented method of claim 34, wherein said user input is made by a customer-relations representative in response to input from a property owner.

37. The computer-implemented method of claim 34, wherein each of said construction project data items are associated with an identification tag that uniquely identifies that data item.

38. A computer-readable medium having computer-executable instructions for performing a method of managing a geographically-expansive transmission line construction project, said method comprising:
maintaining a database comprising construction project data, at least a portion of which includes first geographic location information, and terrain data, at least a portion of which includes second geographic location information;
updating said construction project data in response to inputs from a plurality of users;
correlating said first geographic location information of said construction project data and said second geographic location information of said terrain data;
displaying at least a portion of said construction project data and terrain data in a visual format such that said construction project data appears in a correlated geographic location with respect to said terrain data.

39. The computer-readable medium of claim 38, wherein said plurality of users comprises at least one of the following: a customer relations representative, a project manager, a property owner, a field inspector, a field supervisor, and a field crew.

40. The computer-readable medium of claim 38, wherein said display is monitored by a project manager to ascertain a status of the construction project.

41. The computer-readable medium of claim 38, wherein said user input is made by a customer-relations representative in response to input from a property owner.

42. The computer-readable medium of claim 38, wherein each of said construction project data are associated with an identification tag that uniquely identifies that data item.
